(19) United States
(12) Patent Application Publication
(10) Pub. No.: US 2018/0184180 A1
(43) Pub. Date: Jun. 28, 2018

(54) MEDIA FEED SYNCHRONISATION

(71) Applicant: Nokia Technologies Oy, Espoo (FI)

(72) Inventors: Jukka REUNAMÄKI, Tampere (FI); Juha SALOKANNEL, TAMPERE (FI); Arto PALIN, Akaa (FI)

(21) Appl. No.: 15/759,744

(22) PCT Filed: Sep. 22, 2015
(86) PCT No.: PCT/FI2015/050631

§ 371 Date: Mar. 13, 2018

(51) Int. Cl. H04N 21/8547; H04N 5/77; H04N 21/81; H04N 21/242

(52) U.S. Cl. CPC H04N 21/8547; H04N 5/77; H04W 56/0005; H04N 21/242; H04N 21/812

(57) ABSTRACT

A method and apparatus are disclosed for recording, at a recording device, a media feed relating to a scene; receiving a series of wireless synchronisation messages at the recording device; recording a time stamp value with respect to each of the received messages indicating a time of receipt, and storing the time stamp values and the media feed. A method and apparatus are also disclosed for receiving, from each of a first and second recording device, a media feed recorded by the respective recording device and a series of time stamp values, wherein each time stamp value indicates a time of receipt of one of a series of wireless synchronisation messages at the respective recording device, and aligning the set of time stamp values received from a first recording device with the set of time stamp values received from a second recording device to synchronise the media feed received from the first recording device with the media feed received from the second recording device.

### FIELD

The specification relates to synchronisation of media feeds.

### BACKGROUND

Media recording of the same moment with multiple devices is nowadays common as many people carry mobile devices capable of recording media content. Several video and/or audio feeds relating to the same event may be used in many occasions, while a challenging issue is the efficient video and/or audio synchronization between the different recording devices.

### SUMMARY

In a first aspect, this specification describes a method comprising recording, at a recording device, a media feed relating to a scene; receiving a series of wireless synchronisation messages at the recording device; recording a time stamp value with respect to each of the received messages indicating a time of receipt, and storing the time stamp values and the media feed.

The method may further comprise uploading the time stamp values and the media feed to a remote apparatus for synchronisation with other media feeds.

The interval between messages may be varied randomly or pseudo-randomly.

Each message may contain a coarse synchronisation value and the method may further comprise sending the coarse synchronisation value relating to each time stamp value to the remote apparatus.

The coarse synchronisation value may be a random or pseudo-random variable.

The coarse synchronisation value may be determined from Linear Feedback Shift Register values contained in one or more of the received messages.

The coarse synchronisation value may be derived from a counter value contained in one or more of the received messages.

The method may further comprise associating each time stamp value with a timing instant of the media feed.

Associating each time stamp value with a timing instant of the media feed may comprise applying time stamp data to the media feed as metadata within a media file.

The method may further comprise storing time stamp data in a file separate from the media file.

The method may further comprise commencing recording in response to receiving a message containing an instruction to commence recording.

The method may further comprise storing an identifier of a remote device contained in a received message and scanning for further advertising packets from the remote device having the identifier.

The method may further comprise stopping recording in response to receiving a message containing an instruction to stop recording.

The method may further comprise calculating an angle of arrival of the received messages and outputting the calculated angle of arrival to a remote apparatus.

In a second aspect, this specification describes a method comprising receiving, from each of a first and second recording device, a media feed recorded by the respective recording device and a series of time stamp values, wherein each time stamp value indicates a time of receipt of one of a series of wireless synchronisation messages at the respective recording device, and aligning the set of time stamp values received from a first recording device with the set of time stamp values received from a second recording device to synchronise the media feed received from the first recording device with the media feed received from the second recording device.

The method may further comprise associating the series of time stamp values received from the first recording device with the media feed received from the first recording device and associating the series of time stamp values received from the second recording device with the media feed received from the second recording device.

The method may further comprise receiving coarse synchronisation values from each of the recording devices to using the coarse synchronisation values to coarse-synchronise the respective feeds.

In a third aspect, this specification describes a computer program comprising instructions that, when executed by a computing apparatus, cause the computing apparatus to perform the method of the first aspect or the second aspect.

In a fourth aspect, this specification describes an apparatus comprising at least one processor; at least one memory having computer-readable instructions stored thereon, the computer-readable instructions when executed by the at least one processor causing the apparatus at least to record, at a recording device, a media feed relating to a scene;
receive a series of wireless synchronisation messages at the recording device; record a time stamp value with respect to each of the received messages indicating a time of receipt, and store the time stamp values and the media feed.

In a fifth aspect, this specification describes an apparatus comprising at least one processor; at least one memory having computer-readable instructions stored thereon, the computer-readable instructions when executed by the at least one processor causing the apparatus at least to receive, from each of a first and second recording device, a media feed recorded by the respective recording device and a series of time stamp values, wherein each time stamp value indicates a time of receipt of one of a series of wireless synchronisation messages at the respective recording device, and align the set of time stamp values received from a first recording device with the set of time stamp values received from a second recording device to synchronise the media feed received from the first recording device with the media feed received from the second recording device.

In a sixth aspect, this specification describes a-readable medium having computer-readable code stored thereon, the computer-readable code, when executed by at least one processor, causing performance of recording, at a recording device, a media feed relating to a scene; receiving a series of wireless synchronisation messages at the recording device; recording a time stamp value with respect to each of the received messages indicating a time of receipt, and storing the time stamp values and the media feed.

In a seventh aspect, this specification describes a computer-readable medium having computer-readable code stored thereon, the computer-readable code, when executed by at least one processor, causing performance of receiving, from each of a first and second recording device, a media feed recorded by the respective recording device and a series of time stamp values, wherein each time stamp value indicates a time of receipt of one of a series of wireless synchronisation messages at the respective recording device, and aligning the set of time stamp values received from a first recording device with the set of time stamp values received from a second recording device to synchronise the media feed received from the first recording device with the media feed received from the second recording device.

In an eighth aspect, this specification describes an apparatus comprising means for recording, at a recording device, a media feed relating to a scene; means for receiving a series of wireless synchronisation messages at the recording device; means for recording a time stamp value with respect to each of the received messages indicating a time of receipt, and means for storing the time stamp values and the media feed.

In a ninth aspect, this specification describes an apparatus comprising means for receiving, from each of a first and second recording device, a media feed recorded by the respective recording device and a series of time stamp values, wherein each time stamp value indicates a time of receipt of one of a series of wireless synchronisation messages at the respective recording device, and means for aligning the set of time stamp values received from a first recording device with the set of time stamp values received from a second recording device to synchronise the media feed received from the first recording device with the media feed received from the second recording device.

In a tenth aspect, this specification describes a system comprising a plurality of apparatuses according to the fourth, sixth or eighth aspect and an apparatus according to the fifth, seventh or ninth aspect.

### BRIEF DESCRIPTION OF THE DRAWINGS

For a more complete understanding of the methods, apparatuses and computer-readable instructions described herein, reference is now made to the following descriptions taken in connection with the accompanying drawings in which:

FIG. 1 is a schematic illustration of a recording environment in accordance with various embodiments;

FIG. 2 illustrates a series of advertising events in accordance with various embodiments;

FIG. 3 illustrates a packet structure in accordance with various embodiments;

FIG. 4 illustrates a series of advertising packets and the tagging of a video feed;

FIG. 5 illustrates advertising packets containing instructions for a recording device;

FIG. 6 is a flow chart illustrating steps performed by a recording device in accordance with various embodiments;

FIG. 7 is a flow chart illustrating steps performed by a control device in accordance with various embodiments;

FIG. 8 is a flow chart illustrating steps performed by a recording device in accordance with alternative embodiments;

FIG. 9 is a schematic block diagram illustrating a control device;

FIG. 10 is a schematic block diagram illustrating a recording device; and

FIG. 11 shows a storage means.

### DETAILED DESCRIPTION

Embodiments described in this specification provide a mechanism for wirelessly synchronising video and/or audio feeds recorded by multiple recording devices. This may be done without a wired connection between the recording devices and utilises a time of receipt of a plurality of wireless synchronisation messages received in series, such as Bluetooth Low Energy (BLE) advertisement messages transmitted by a control device. In the following description, the terms packets and messages may be used interchangeably.

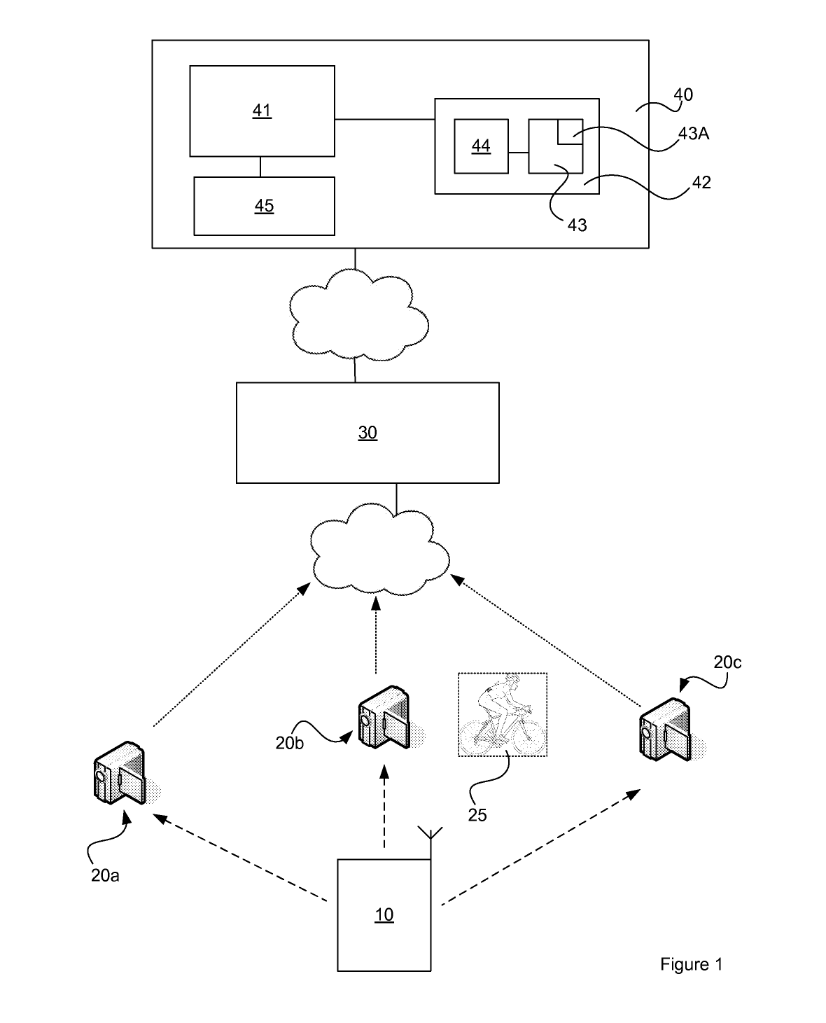

FIG. 1 shows a system 100 comprising a control device 10 and a plurality of recording devices 20. The control device 10 is configured to transmit a series of BLE advertising packets to enable control of the recording devices 20. It should be borne in mind however that one or more of the recording devices 20 may take the place of the controlling device 10. In other words, one or more of the recording devices 20 may be equipped with a BLE module and may send the advertisement messages in addition to recording the event. In the example shown in FIG. 1, recordings can be synchronized based on wireless transmission. In this example, there is one device transmitting and three devices receiving but, for example, all devices may transmit their own signal and receive signals from the other devices.

In the example shown in FIG. 1, three cameras are each recording a video of an extreme sport event 25. The time synchronisation between videos is arranged by tagging a recorded video and/or audio stream at times in the audio/video feed corresponding to the receipt of the BLE messages. The control device 10 has a BLE module which is advertising certain information over the BLE protocol. The control device may be a smartphone, or other computing device. Information contained within successive BLE messages may change according to the recording phase, e.g. an initial BLE message may contain an instruction for the recording device 20 to commence a recording. A subsequent BLE message may contain an instruction to stop a recording.

Each of the recording devices 20 comprises a BLE module which may be configured to scan for BLE advertisement messages. For example, a certain UUID corresponding to the media recording application and a certain Camera ID corresponding to the control device 10 may be searched for.

Each of the recording devices 20 is configured to record time instants, for example an instant when an advertisement with a certain UUID has been received. Alternatively, each of the recording devices 20 is configured to record time instants when any advertisement message is received. The UUID may be monitored so that only those advertisements from the correct control device 10 are used in the synchronisation process. Alternatively, the UUID information contained within a message may be used only to filter out control packets used to control media recording so that only messages containing instructions to start or stop recording received from a particular control device 10 cause the recording device 20 to start, pause or stop a recording.

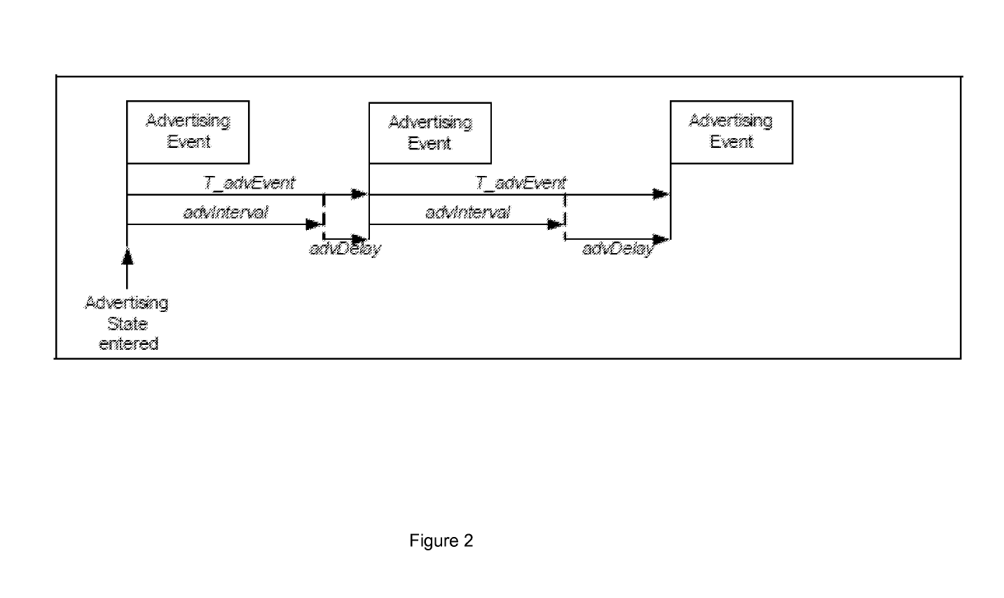

The control device 10 sends BLE advertisement messages in advertising events, as shown in FIG. 2. Each advertising event is composed of one or more BLE advertisement messages sent on used advertising channel indices. The advertising event may be closed after one BLE advertisement message has been sent on each of the used advertising channel indices or the control device 10 may close an advertising event earlier to accommodate other functionality.

An advertising event can be one of the following types as defined in the Bluetooth specification v4.2:
a connectable undirected event
a connectable directed event
a non-connectable undirected event
a scannable undirected event

For all undirected advertising events or connectable directed advertising events used in a low duty cycle mode, the time between the start of two consecutive advertising events (T_advEvent) may be computed as follows for each advertising event:

T_advEvent=advInterval+advDelay

The advInterval may be an integer multiple of 0.625 ms in the range of 20 ms to 10.24 s. If the advertising event type is either a scannable undirected event type or a non-connectable undirected event type, the advInterval may be at least 100 ms. If the advertising event type is a connectable undirected event type or connectable directed event type used in a low duty cycle mode, the advInterval may be 20 ms or greater.

The advDelay is a pseudo-random value with a range of 0 ms to 10 ms generated by the data link layer for each advertising event. The advDelay may also be referred to as advertisement jitter.

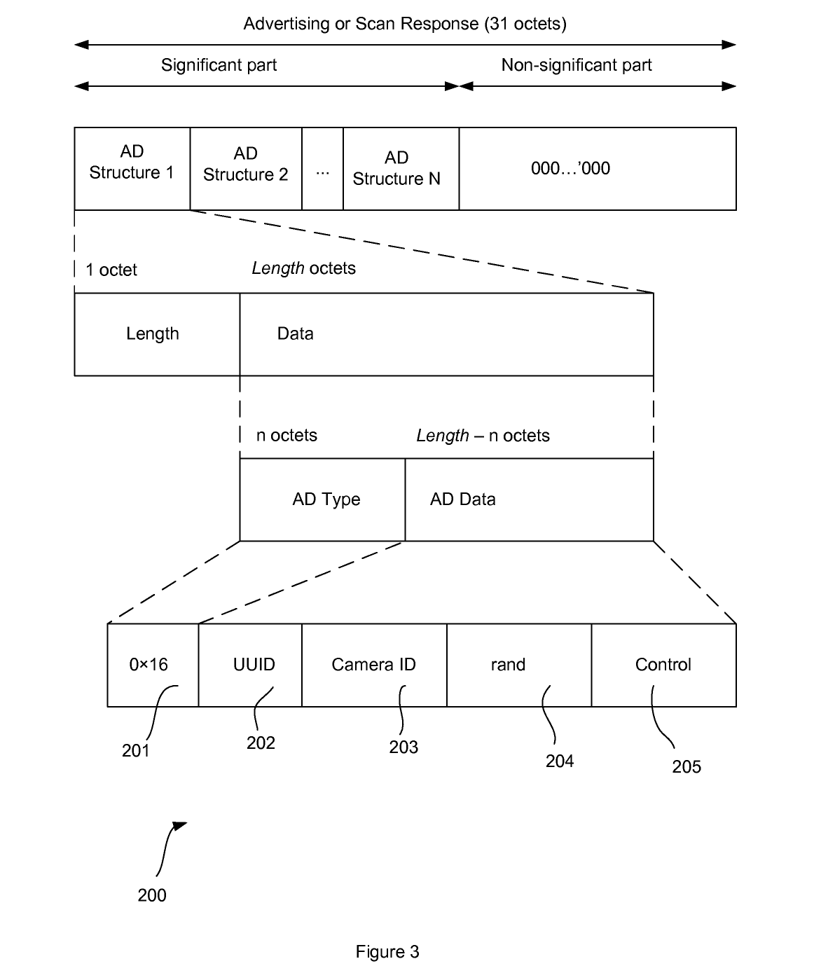

The format of advertising data and scan response data is shown in FIG. 3. The data comprises a significant part and a non-significant part. The significant part contains a sequence of AD structures. Each AD structure may have a Length field of one octet, which contains the Length value, and a Data field of Length octets. The first octet of the Data field contains the AD type field. The content of the remaining Length−1 octet in the Data field depends on the value of the AD type field and is called the AD data. The non-significant part extends the Advertising and Scan Response data to 31 octets and may contain all-zero octets. Only the significant part of the Advertising or Scan Response data needs to be transmitted. The Advertising and Scan Response data is sent in advertising events. The Advertising Data is placed in the AdvData field of ADV_IND, ADV_NONCONN_IND, and ADV_SCAN_IND packets. The Scan Response data is sent in the ScanRspData field of SCAN_RSP packets. This is in accordance with the Bluetooth specification v4.0.

The data structure shown in FIG. 3 is only part of the transmitted packet, which includes a preamble, an access address, a PDU, and a CRC field. The PDU itself comprises a header and a payload. The payload of the PDU comprises AdvData. The AdvData field comprises the advertising data structure of a BLE advertisement message 200.

An example of the specific advertising data structure of a BLE advertisement message 200 which may be used for synchronization is shown in FIG. 3. The BLE advertisement message 200 contains advertising data type field 201 “0x16” which may be “Service Data—16-bit UUID” used to identify that the service data for specific 16-bit UUID will follow. The data structure 200 contains a UUID field 202. An example UUID may be 0xFFFF. A camera ID field 203 contains the identifier of the transmitting device 10 and a rand field 204 may be a random or pseudo-random number changed periodically and can thus be used to discover recordings later which were recorded in the same area at the same time. As will be described in more detail below, the presence of the random or pseudo-random value allows for the alignment and synchronisation of multiple video or audio feeds. The advertisement message may also include, for example, transmitter status (for example “idle” or “recording”) or a coarse time stamp. The coarse time stamp may be transmit time stamp included in the packet structure 200 by the control device 10 as the packet is transmitted.

The data structure 200 may comprise a control data field 205. The control data field 205 may be, for example, 1 octet in length. A hexadecimal entry of 0x00 may mean “start recording” and a hexadecimal entry of 0x01 may be represent “stop/pause recording” instruction. Therefore, an early message transmitted by the control device 10 may have a control data field 205 value of 0x00 to start the recording. A later message may contain a control data field 205 value of 0x01 to stop the recording.

The advertisement message may also include data which can be used to estimate the relative orientation of the recording devices 20 with respect to the control device 10 using, for example, angle of arrival (AoA) and angle of departure (AoD) methods. AoA and/or AoD can be used to estimate relative positions of the recording devices 20 and may be used for example in the audio/video editing phase to position the media in space in addition to time synchronization.

The BLE advertisement message structure shown in FIG. 3 helps in processing received data packets, for example when processing data afterwards. Coarse synchronization time can be searched more easily and then fine tuning with the recorded time stamps for advertisement packets may be performed. The contents of the rand field 204 in each received packet can be used to perform coarse timing synchronisation of the media feeds recorded by various recording devices 20. After the same rand field values are found from the each of recordings, the respective feeds can be coarse aligned.

Fine tuning may then be performed by comparing receipt (RX) time stamps applied to advertisement messages received at each of the recording devices, as shown in FIG. 3. The jitter applied to the transmission of the series of advertisement messages allows for the fine alignments of the media feeds recorded at the various recording devices. As such, the feeds may be synchronised by aligning the RX timestamps of the various recording devices 20.

The recording devices 20 receive the BLE advertisement packets from the control device 10 and time stamp the time of receipt of the advertisement packets. In some embodiments, the time stamps are applied as tags to a video and/or audio feed file that is being recorded by the recording device 20. In other embodiments, the time stamps are stored separately.

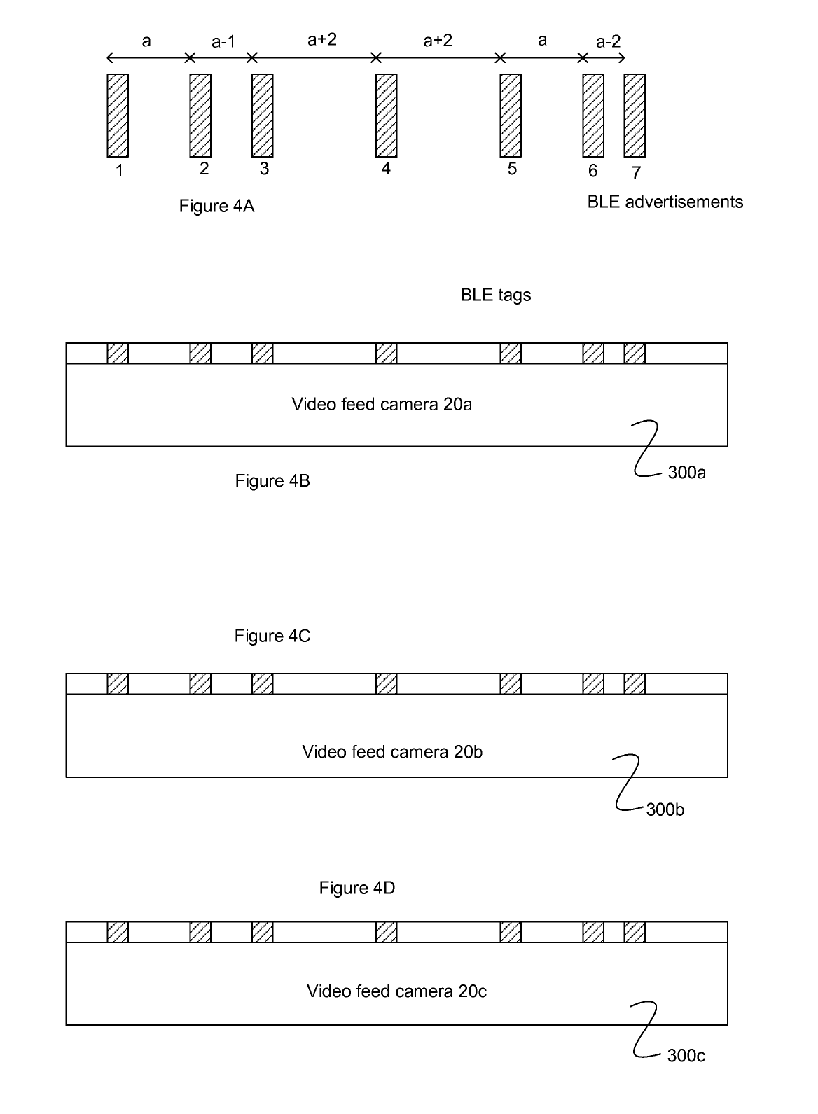

FIGS. 4A-D illustrate a timeline of advertisement messages. In each of these figures, time runs along the x axis.

FIG. 4A represents a series of seven BLE advertisement messages being transmitted by the control device 10. The BLE advertisement messages are separated by an interval. The BLE advertisement interval between the first and second messages may be a ms. The interval between the second and third messages may be a−1 ms. The interval between the third and fourth messages may be a+2 ms and so forth. The variation in the interval is due to jitter which corresponds to the introduction of a random or pseudo-random advDelay value created by the control device 10 and is shown in FIG. 2.

The jitter introduced to the interval may be contained in the packet itself in the rand field 204. The variation in the interval between successive BLE advertisement messages allows for the audio/video feeds to be synchronised. If the interval between BLE advertisement messages were constant, the intervals between successive BLE advertisement messages would not be differentiable and so video synchronisation would not be possible due to the many possible permutations of media file alignment that would be possible.

FIGS. 4B, 4C and 4D show respective video feeds 300a, 300b, and 300c being tagged with tags corresponding in time to the BLE advertisement messages by each of the recording devices 20a, 20b, 20C shown in FIG. 1. The application of timing values corresponding to the RX time stamps of the received BLE messages may be performed by the respective recording device 20a, 20b, 20C. The tagged feeds may then be sent to a remote apparatus such as a video editing computer or server to be synchronised.

Alternatively, the recorded media feeds may be output to a remote server together with the RX time stamps relating to the received BLE advertisement messages stored as a separate file so that the tagging of the feeds is performed remotely. The feeds, tagged remotely from the recording devices 20, may then synchronised at a remote apparatus such as a video editing computer.

The recording devices 20 may identify that the received messages are BLE advertisement messages transmitted from the control device 10 from the UUID field 202. This content may be used for recording devices 20 to search for BLE advertisement messages in order to stamp the video feed. The recording devices 20 may record only for example the timestamp and the BLE identifier of all received packets.

Each recording device 20 may stored the recorded video feeds and time stamp data locally, for example on a memory card. The video feeds and time stamp data may be uploaded, for example to a remote server 30 after users have recorded videos from the event. Alternatively, the video feeds and time stamp data may be stored at a network attached storage (NAS) device. The recording devices 20 shown in FIG. 1 comprise a wireless transceiver and antenna to allow the media feeds to be uploaded wirelessly to the remote server 30. The remote server 30 may be accessed by an editing apparatus 40 which may be a single computer or an editing suite configured to perform synchronisation and editing of audio and/or video feeds.

The editing apparatus 40 may be a computer comprising a processor 41, a storage device 42 (having a non-volatile memory 43 and a volatile memory 44) and a user input/output 45. The non-volatile memory 43 may have code 43A stored thereon in the form of an operating system and software. The user/input 45 comprises input and output units such as a monitor, speakers, keyboard, mouse and so forth. Input and output functions may be combined in the form of a touchscreen.

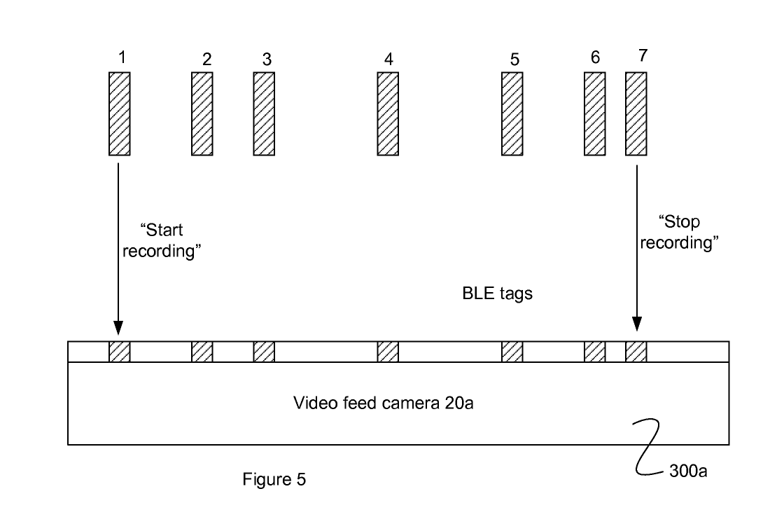

The editing apparatus 40 may apply the time stamps to the audio/video feeds, as represented in FIG. 5. Alternatively, the time stamps may be applied to the video feed by the respective recording device 20.

In some embodiments, the synchronisation process may be as follows. Video editing software (which is stored in the non-volatile memory 43 of the editing apparatus 40) takes the video from the first recording device 20a and which corresponds to the video feed recorded in FIG. 4B. The time positions of the BLE advertisement tagging in the video timeline are recorded. The start of the recording tag may be handled first. In the second video the same position is searched and the two video feeds are synchronised. Likewise, the third video feed is synchronised with the first two feeds and so on. After this multiple BLE advertisement tag positions are recorded from the first video and the corresponding tag positions are searched in the next videos and the videos are synchronised/aligned respectively.

Table 1 shows information collected at a first recording device 20a. The first recording device 20a may be recording a video. A series of nine BLE advertisement messages are received. The first message is received at a time corresponding to 00:00:134 in the video timeline. The message is received from a device 10 having a MAC address 87:23:11:09:23:14. The first message contains data A22. Subsequent messages are received from the device 10 having MAC address 87:23:11:09:23:14. Timing values corresponding to time instants in the recorded media feed are also recorded.

TABLE 1

| Time | MAC Address | Data |
|---|---|---|
| 00:00:134 | 87:23:11:09:23:14 | A22 |
| 00:01:023 | 87:23:11:09:23:14 | A23 |
| 00:01:345 | 87:23:11:09:23:14 | A23 |
| 00:02:576 | 87:23:11:09:23:14 | A23 |
| 00:03:753 | 87:23:11:09:23:14 | A24 |
| 00:03:915 | 87:23:11:09:23:14 | A24 |
| 00:04:097 | 87:23:11:09:23:14 | A24 |
| 00:04:349 | 87:23:11:09:23:14 | A25 |
| 00:04:436 | 87:23:11:09:23:14 | A25 |

TABLE 2

| Time | MAC Address | Data |
|---|---|---|
| 00:00:234 | 87:23:11:09:23:14 | A21 |
| 00:01:445 | 87:23:11:09:23:14 | A22 |
| 00:02:823 | 87:23:11:09:23:14 | A22 |
| 00:04:532 | 87:23:11:09:23:14 | A22 |
| 00:05:235 | 87:23:11:09:23:14 | A22 |
| 00:06:124 | 87:23:11:09:23:14 | A23 |
| 00:06:446 | 87:23:11:09:23:14 | A23 |
| 00:07:677 | 87:23:11:09:23:14 | A23 |
| 00:08:359 | 87:23:11:09:23:14 | A24 |
| 00:08:854 | 87:23:11:09:23:14 | A24 |

Similarly, the messages are also received at the second recording device 20b. Timing information, MAC address of the transmitting device 10 and additional data is likewise recorded, as shown in Table 2.

The synchronisation application identifies from the coarse synchronisation data obtained from each recording device 20 a pattern of received messages that may be synchronised. The coarse synchronisation data entries in Tables 1 and 2 that are highlighted in bold are identified as relating to receipt of BLE messages at respective recording devices 20 that may be synchronised. Fine synchronisation of the audio/video feeds may then be performed.

TABLE 3

| Time 1 | Time 2 | Difference |
|---|---|---|
| 00:00:134 | 00:05:235 | 00:05:101 |
| 00:01:023 | 00:06:124 | 00:05:101 |
| 00:01:345 | 00:06:446 | 00:05:101 |
| 00:02:576 | 00:07:677 | 00:05:101 |
| | 00:08:359 | Packet loss |
| 00:03:753 | 00:08:854 | 00:05:101 |

The timing values in the respective media timelines of the recorded feeds that correspond to the receipt of the series of BLE advertisement messages are compared. As shown in Table 3, the difference between the receipt times in the first media feed and the second media feed is constant for the series of BLE advertisement messages. This indicates that the two media feeds are synchronised. The synchronisation may still be completed even though the first device 20a failed to receive the fifth BLE advertisement messages.

In alternative embodiments, the BLE advertisement message comparison could be performed firstly by creating a timeline where the recordings are taken and videos are selected based on the timeline for producing one editorial video. Server 30 may contain multiple videos and the user of the editing apparatus 40 may select videos from certain area at the certain time, for example, “video of a concert that occurred yesterday at 18:00-20:00 at Tampere city centre”.

In alternative embodiments, BLE advertisement messages can also be received and recorded by the recording devices before the recording. In this case, time stamps corresponding to the BLE advertisement messages are recorded and compared to the timeline of the video or audio file after the recording has been stopped.

In alternative embodiments, BLE advertisement messages can also be received and recorded by the recording devices after the recording. In this case, time stamps corresponding to the BLE advertisement messages may be applied to the video or audio file after the final BLE advertisement message has been received. The last received BLE advertisement message may contain an instruction to say that the BLE advertisement message is indeed the final one. The recording device 20 or a remote device may then applies the tags to the timeline of the video or audio file video file.

As explained above, BLE transmitters can be located in a remote control device 10 or in recording devices 20 such as cameras. Alternatively, the BLE transmitters may be BLE beacon tags that are not otherwise involved with the recording process but whose BLE advertisement messages may be used for synchronization.

The data received during the recording may be included to media recording for example as metadata within the video file or audio file. Alternatively, the received timing data may be contained in a separate file.

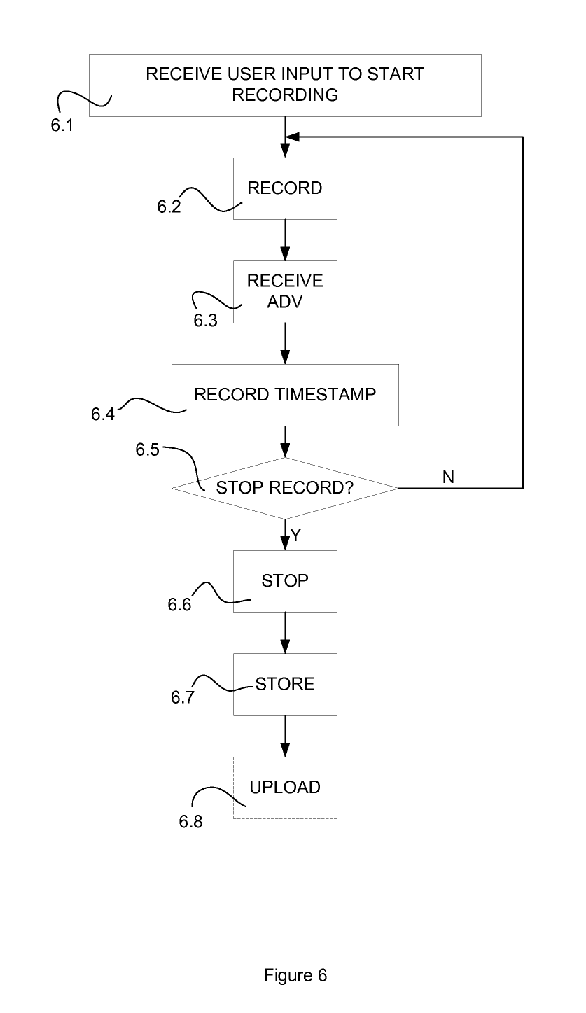

FIG. 6 is an operational flow chart showing the steps performed by each recording device 20 that is recording the event 25. The recording device 20 comprises a transceiver and can therefore receive advertisement messages. Each recording device 20 shown in FIG. 1 performs the following steps independently of each other.

At step 6.1, the recording device 20 receives a user input to start recording the event 25. This may be caused by a user pressing a physical or graphical record button on the recording device 20. At step 6.2, the recording device records the event 25. The recording may be a video recording, an audio recording or a video and audio recording. At step 6.3, the recording device 20 receives a BLE advertisement message. The recording device 20 may apply a time stamp to the received message and store the time stamp value at step 6.4. Additionally, coarse synchronisation data may stored at this step. Steps 6.2, 6.3 and 6.4 are repeated until the recording device 20 detects that it should stop recording at step 6.5. This may be in response to a user input to stop recording. This may be caused by a user pressing a physical or graphical stop button on the recording device 20. The recording device 20 stops recording at step 6.6. At step 6.7, the tagged video/audio file is stored, for example on a memory card of the recording device 20. Optionally, the stored video/audio file and BLE advertisement data may be uploaded at step 6.8 to the server 30.

In the above example shown in FIG. 6, the tags are applied in response to receipt of BLE advertisement messages received from a remote source such as the control device 10. However, the record and stop instructions are inputted by a user of the recording device 20.

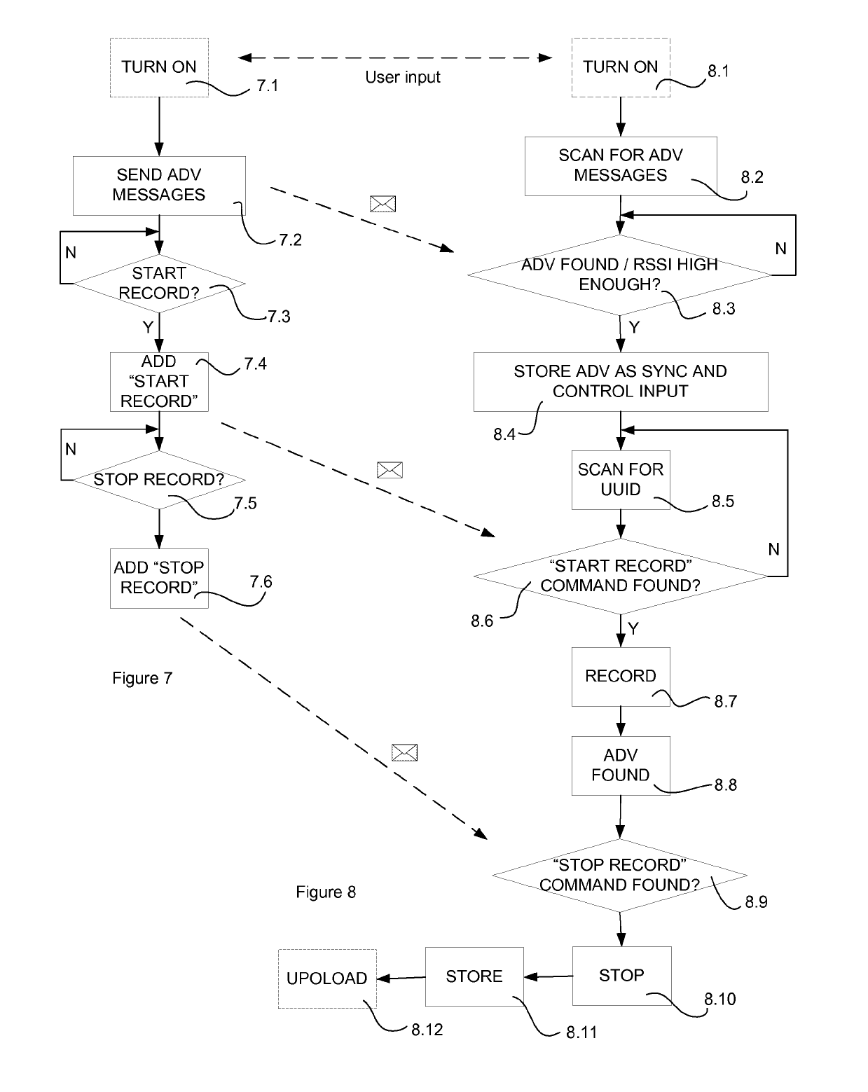

In other embodiments, the record and stop instructions are contained within the BLE advertisement messages themselves. FIG. 7 is a flow chart showing the steps performed by a control device 10 in such an example. FIG. 7 is a flow chart showing the corresponding steps taken by one of the recording devices 20.

Referring to FIG. 7, at step 7.1, the control device 10 may be switched on and multi-camera mode is selected. At step 7.2, BLE advertisement messages of a type shown in FIG. 2 are transmitted to the recording devices 20. At step 7.3, it is determined whether a physical or graphical record button of the control device 10 has been pressed. At step 7.4, in response to the record input being received at the control device 10, a ‘record’ instruction is included in one or more BLE advertisement messages which serve to instruct recording devices that receive the BLE advertisement messages to begin recording. At step 7.5, a stop button is pressed. Alternatively, the record button is pushed for a second time which is indicative of an instruction to stop recording. A ‘stop’ instruction is then included in one or more subsequent BLE advertisement messages at step 7.6.

Referring to FIG. 8, at step 8.1, the recording device 20 may be switched on by a user input. At step 8.2, the recording device 20 scans for BLE advertisement messages. At step 8.3, the recording device 20 determines if a BLE advertisement message has been received. The recording device 20 can also measure a received signal strength indication (RSSI) value for the received BLE advertisement message. The recording device 20 may determine and record a timestamp for each received message. If the RSSI value is above a minimum threshold then the process moves on to step 8.4. At step 8.4, information contained within the received BLE advertisement message is stored at the recording device 20 such as the Camera ID 203 of the control device 10. At step 8.5, the recording device 20 scans for advertisement messages containing the UUID transmitted by the control device 10. Subsequent BLE advertisement message are received at the recording device 20. At step 8.6, if a BLE advertisement message is received from the control device 10 containing a record instruction, the recording device starts to record the event 25 at step 8.7. The recording may be a video and/or audio recording. Further BLE advertisement messages are transmitted from the control device 10 and are received by the recording device 20 and timestamped at step 8.8. Coarse synchronisation data may also be stored. If it is determined at step 8.9 that a BLE advertisement message contains a ‘stop’ instruction then the recording is stopped at step 8.10. Once the stop instruction has been received, the process moves from step 8.10 to step 8.11 wherein the feed and time stamp data are stored, for example on a memory card. The feed and time stamp data may subsequently be uploaded to the server 30 at step 8.12.

In one embodiment of the invention, Linear Feedback Shift Register (LFSR) based pseudo-random advertising is used. The control device 10 reports its LSFR state value within an advertising packet, which makes it possible for the recording device 20 (that has similar LFSR) to calculate when the next advertising packets will come from the same control device 10. The LFSR value (or again the timings of the received adverts) can be stored and compared to synchronize the videos. The LSFR value used for the advertisement jitter generation may be used to estimate previous and following advertisement instants.

The jitter (advDelay) value may be pseudo-random instead of true random, and thus may be generated using the LSFR. If this value is received in at least one advertisement, in addition to advertisement interval (advInterval in FIG. 2) all the previous and following advertisement transmission times can be calculated. For longer periods there can be significant drift, in BLE this can be for example 0.5 ms per second which is relatively high and thus this may mainly be used for coarse synchronization.

Furthermore, the LSFR value can be for example used to estimate packet reception times of the packets which were not received or to estimate packet reception times outside recording time. In some cases this could be used instead of advertisement jitter due to jitter is defined by LSFR.

In another embodiment, a counter is added to the advertising packet payload. The counter value is increased by one at every advertising event. The counter value can be stored by the recording devices 20 and used for synchronizing/aligning the videos. The packet reception times are recorded and compared to media feed timeline and the counter value is also stored in the advertisement data file.

In this embodiment the counter value takes the place of the rand field 204. The counter is increased every packet by the radio transceiver and rand 204 is updated by upper SW layers which doesn't have knowledge or control of actual transmissions of the packet, thus it is updated less frequently, for example once in 30 s.

After the tagged media files have been uploaded by each of the recording devices 20 to the server 30, the video editing computer 40 may then align the feeds from the respective recording devices 20 to synchronise the recordings from multiple recording devices by correlating advertisements tagged to the multiple recordings. Furthermore, geolocation and coarse timing information may be used. Geolocation may be based on coordinates recorded by the recording device 20 for example using GPS. Location may also be based on advertisement devices MAC address or Camera ID 203.

The BLE advertisement messages may be used by the control device 10 and recording devices 20 to determine angle-of-arrival (AoA) or angle-of-departure (AoD) information. Each of the recording devices 20 may be provided with an antenna array and code to provide this functionality.

The BLE advertisement messages transmitted by the control device 10 may also serve as AoA packets and the recording devices 20 execute antenna switching during the reception of the packets. The recording devices 20 scan for the BLE advertisement messages and execute amplitude and phase sampling during reception of these packets. The recording devices 20 may then utilize the amplitude and phase samples, along with its own antenna array information, to estimate the AoA of the packet from the control device 10. This information may be stored along with the time stamp information and audio/video feed and subsequently uploaded.

In embodiments using AoD, the control device 10 comprises an array of antennas. The control device 10 acts as a position beaconing device transmitting BLE advertisement messages which also act as AoD packets. The control device 10 executes antenna switching during the transmission of the packet. The recording devices 20 act as tracker devices and scan for the AoD packets and execute amplitude and phase sampling during reception of these packets. The recording devices 20 may then utilize the amplitude and phase samples, along with antenna array parameter information, to estimate the AoD of the packet from the control device 10.

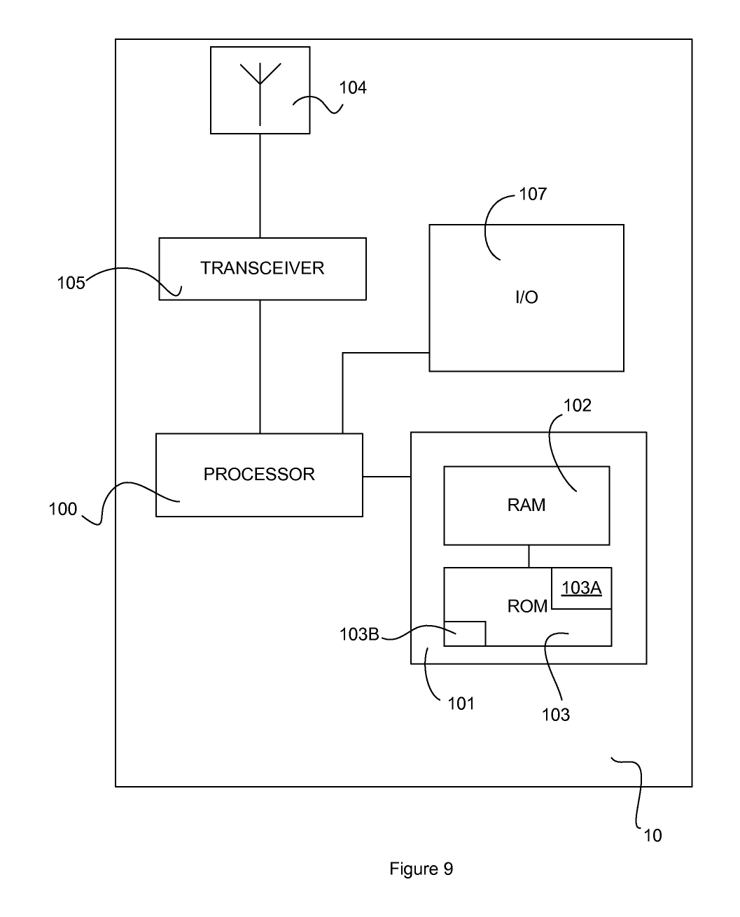

FIG. 9 is a schematic block diagram of the control device 10. The control device 10 comprises a processor 100, a storage device 101 (comprising a volatile memory 102 and a non-volatile memory 103) and an antenna 104. In embodiments where the control device 10 is configured to perform AoD calculations, the control device comprises an array of antennas. The control device 10 also comprises a transceiver 105. The non-volatile memory 103 has computer code 103A and a Bluetooth module 103B stored thereon to enable the control device 10 to perform its functionality. The programming instructions 103A relate to the particular functionality of the control device 10 in embodiments of the present invention. The programming instructions 103A allow sent packets to be processed in accordance with the High Accuracy Indoor Positioning (HAIP) solution, for example as described at http://www.in-location-alliance.com. The Bluetooth module 103B contains computer readable instructions to cause control device 10 to transmit packets signals/positioning packets according to the BLE standard. The processor controls the BLE module 103B to transmit the series of BLE advertisement messages. As mentioned above, the control device 10 may be a smartphone or other type of computing device capable of wireless communication. As such, the control device 10 may comprise a user input/output 107. The user input/output 107 may be a smartphone touchscreen to enable user control of the functionality of the control device 10 described above.

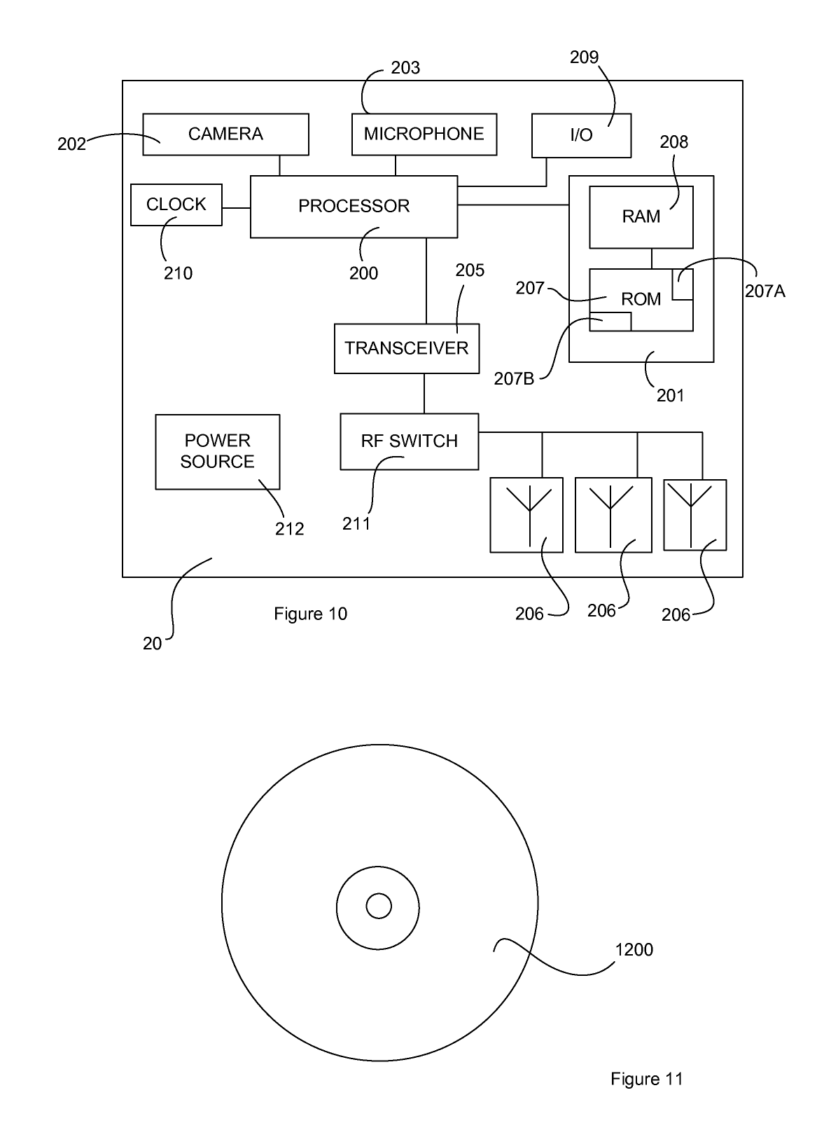

FIG. 10 is a schematic block diagram of one of the recording devices 20. The recording device 20 comprises a processor 200, a storage device 201, a camera module 202, a microphone 203, a transceiver 205 and an array of antennas 206. The storage device 201 may comprise a non-volatile memory 207 (such as ROM) on which computer readable code 207A and a Bluetooth module 207B is stored and a volatile memory 208 (such as RAM). The programming instructions 207A relate to the particular functionality of the recording devices 20 in embodiments of the present invention. The programming instructions 207A allow received packets to be processed in accordance with the High Accuracy Indoor Positioning (HAIP) solution. The recording device 20 also comprises a user input/output 209. The input/output 209 may comprise one or more physical buttons and a screen. Alternatively, the input/output 209 may be a touchscreen. The recording device may comprise a memory card (not shown). The recording device 20 comprises a clock 210. The clock 210 is used to timestamp received packets. The recording device 20 comprises a RF switch 211 to perform the antenna switching. The recording device 20 also comprises a power source 212 such as a battery or a connection to a mains power supply.

The camera module 202 comprises hardware and software components required to record still and motion pictures as is known in the art. For example, the camera module 202 comprises a lens, a CMOS sensor or CCD image sensor for image sensing and so forth.

The video and audio processors may be separate processors, may be combined in a single multimedia processor or, as shown in FIG. 10, the processing functionality of the camera 102 and microphone 103 may be performed by the main processor 100.

The computer readable instructions may be pre-programmed into the apparatuses 10, 20, 40. Alternatively, the computer readable instructions may arrive at the apparatuses 10, 20, 40 via an electromagnetic carrier signal or may be copied from a physical entity 1200 (see FIG. 11) such as a computer program product, a memory device or a record medium such as a CD-ROM or DVD. The computer readable instructions may provide the logic and routines that enables the devices/apparatuses 10, 20, 40 to perform the functionality described above.

Whilst embodiments have been described using BLE messages, alternative low-power radio technologies may be used such as IEEE 802.15.4 or 802.11.

The term ‘memory’ when used in this specification is intended to relate primarily to memory comprising both non-volatile memory and volatile memory unless the context implies otherwise, although the term may also cover one or more volatile memories only, one or more non-volatile memories only, or one or more volatile memories and one or more non-volatile memories. Examples of volatile memory include RAM, DRAM, SDRAM etc. Examples of non-volatile memory include ROM, PROM, EEPROM, flash memory, optical storage, magnetic storage, etc.

Embodiments of the present disclosure may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer.

A computer-readable medium may comprise a computer-readable storage medium that may be any tangible media or means that can contain or store the instructions for use by or in connection with an instruction execution system, apparatus, or device, such as a computer as defined previously.

According to various embodiments of the previous aspect of the present disclosure, the computer program according to any of the above aspects, may be implemented in a computer program product comprising a tangible computer-readable medium bearing computer program code embodied therein which can be used with the processor for the implementation of the functions described above.

Reference to “computer-readable storage medium”, “computer program product”, “tangibly embodied computer program” etc, or a “processor” or “processing circuit” etc. should be understood to encompass not only computers having differing architectures such as single/multi processor architectures and sequencers/parallel architectures, but also specialised circuits such as field programmable gate arrays FPGA, application specify circuits ASIC, signal processing devices and other devices. References to computer program, instructions, code etc. should be understood to express software for a programmable processor firmware such as the programmable content of a hardware device as instructions for a processor or configured or configuration settings for a fixed function device, gate array, programmable logic device, etc.

By way of example, and not limitation, such “computer-readable storage medium” may mean a non-transitory computer-readable storage medium which may comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood, however, that “computer-readable storage medium” and data storage media do not include connections, carrier waves, signals, or other transient media, but are instead directed to non-transient, tangible storage media. Disk and disc, as used herein, include compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of “computer-readable medium”.

Instructions may be executed by one or more processors, such as one or more digital signal processors (DSPs), general purpose microprocessors, application specific integrated to circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

If desired, the different steps discussed herein may be performed in a different order and/or concurrently with each other. Furthermore, if desired, one or more of the above-described steps may be optional or may be combined.

Although various aspects of the present disclosure are set out in the independent claims, other aspects of the present disclosure comprise other combinations of features from the described embodiments and/or the dependent claims with the features of the independent claims, and not solely the combinations explicitly set out in the claims.

1-40. (canceled)

41. A method comprising:
recording, at a recording device, a media feed relating to a scene;
receiving, at the recording device, a series of wireless synchronisation messages, the messages comprising Bluetooth Low Energy (BLE) advertisement messages;
recording a time stamp value with respect to each of the received messages indicating a time of receipt, and
storing the time stamp values and the media feed.

42. The method of claim 41, further comprising uploading the time stamp values and the media feed to a remote apparatus for synchronisation with other media feeds.

43. The method of claim 41, wherein each message contains a coarse synchronisation value and the method further comprises sending the coarse synchronisation value relating to each time stamp value to the remote apparatus.

44. The method of claim 43, wherein the coarse synchronisation value is at least one of:
a) a random or pseudo-random variable,
or
b) is determined from Linear Feedback Shift Register values contained in one or more of the received messages,
or
c) is derived from a counter value contained in one or more of the received messages.

45. The method of claim 41, further comprising associating each time stamp value with at least one of:
a) a timing instant of the media feed,
or
b) a timing instant of the media feed comprises applying time stamp data to the media feed as metadata within a media file,
or
c) further comprising storing time stamp data in a file separate from the media file.

46. The method of claim 41, further comprising;
a) commencing recording in response to receiving a message containing an instruction to commence,
or
b) stopping recording in response to a message containing an instruction stop recording.

47. The method of claim 46, further comprising storing an identifier of a remote device contained in a received message and scanning for further advertising packets from the remote device having the identifier.

48. The method of claim 41, further comprising calculating an angle of arrival of the received messages and outputting the calculated angle of arrival to a remote apparatus.

49. A method comprising:
receiving, from each of a first and second recording device, a media feed recorded by the respective recording device and a series of time stamp values, wherein each time stamp value indicates a time of receipt of one of a series of wireless synchronisation messages, comprising Bluetooth Low Energy (BLE) advertisement messages, at the respective recording device, and
aligning the set of time stamp values received from a first recording device with the set of time stamp values received from a second recording device to synchronise the media feed received from the first recording device with the media feed received from the second recording device.

50. The method of claim 49, further comprising associating the series of time stamp values received from the first recording device with the media feed received from the first recording device and associating the series of time stamp values received from the second recording device with the media feed received from the second recording device.

51. Apparatus comprising:
at least one processor;
at least one memory having computer-readable instructions stored thereon, the computer-readable instructions when executed by the at least one processor causing the apparatus at least to:
record, at a recording device, a media feed relating to a scene;
receive, at the recording device, a series of wireless synchronisation messages, the messages comprising Bluetooth Low Energy (BLE) advertisement messages;
record a time stamp value with respect to each of the received messages indicating a time of receipt, and
store the time stamp values and the media feed.

52. The apparatus of claim 51, the computer-readable instructions when executed by the at least one processor causing the apparatus at least to upload the time stamp values and the media feed to a remote apparatus for synchronisation with other media feeds.

53. The apparatus of claim 51, wherein each message contains a coarse synchronisation value and the computer-readable instructions when executed by the at least one processor causing the apparatus at least to send the coarse synchronisation value relating to each time stamp value to the remote apparatus.

54. The apparatus of claim 51, wherein the coarse synchronisation value is at least one of:
a) a random or pseudo-random variable,
or
b) is determined from Linear Feedback Shift Register values contained in one or more of the received messages,
or
derived from a counter value contained in one or more of the received messages.

55. The apparatus of claim 51, the computer-readable instructions when executed by the at least one processor causing the apparatus at least to at least one:
a) associate each time stamp value with a timing instant of the media feed,
or
b) a timing instant of the media feed comprises applying time stamp data to the media feed as metadata within a media file,
or
c) at least to store time stamp data in a file separate from the media file.

56. A non-transitory computer-readable storage medium having computer-readable code stored thereon, the computer-readable code, when executed by at least one processor, causing performance of:
recording, at a recording device, a media feed relating to a scene;
receiving, at the recording device, a series of wireless synchronisation messages, the messages comprising Bluetooth Low Energy (BLE) advertisement messages;
recording a time stamp value with respect to each of the received messages indicating a time of receipt, and
storing the time stamp values and the media feed.
